(19) United States
(12) Patent Application Publication
(10) Pub. No.: US 2022/0377286 A1
(43) Pub. Date: Nov. 24, 2022

(54) DISPLAY CONTROL DEVICE, DISPLAY CONTROL METHOD, AND DISPLAY CONTROL PROGRAM

(71) Applicant: TOYOTA JIDOSHA KABUSHIKI KAISHA, Aichi-ken (JP)

(72) Inventors: Kota WASHIO, Suntou-gun (JP); Shuhei MANABE, Toyota-shi (JP)

(21) Appl. No.: 17/724,494

(22) Filed: Apr. 20, 2022

(30) Foreign Application Priority Data
May 20, 2021 (JP) 2021-085568

(51) Int. Cl. H04N 7/18; G06V 20/59; G06F 3/14

(52) U.S. Cl. CPC H04N 7/185; G06V 20/597; G06F 3/14

(57) ABSTRACT

An acquisition unit that acquires a facial image of a driver of a vehicle captured by an imaging unit, a determination unit that determines appropriateness of continuation of driving by the driver based on the facial image acquired by the acquisition unit, and a control unit that, in a case where the determination unit determines that there is a possibility that the continuation of the driving by the driver is not appropriate, causes a display unit on a manager side, the manager managing the driver, to display the facial image based on which the determination unit determines that there is the possibility that the continuation of the driving by the driver is not appropriate are provided.

### CROSS-REFERENCE TO RELATED APPLICATION

This application claims priority to Japanese Patent Application No. 2021-085568 filed on May 20, 2021, incorporated herein by reference in its entirety.

### BACKGROUND

### 1. Technical Field

The present disclosure relates to a display control device, a display control method, and a display control program.

### 2. Description of Related Art

Japanese Unexamined Patent Application Publication No. 2007-304705 (JP 2007-304705 A) discloses a technique for encouraging a driver to be more awake.

### SUMMARY

In the technique disclosed in JP 2007-304705 A, an electronic control device detects a blinking state of a driver based on an image of the face of the driver captured by a camera, and determines whether the driver feels drowsy based on the detected blinking state of the driver.

However, when the above-mentioned electronic control device determines whether the driver is drowsy based on the blinking state of the driver, for example, there is a possibility that the driver may be erroneously determined to be drowsy in the case where the driver closes his or her eyes for a long time because a foreign substance accidentally enters the eyes. When a warning is issued to the driver based on such an erroneous determination, the driver feels annoyed. Further, for example, there is a possibility that, when detection of blinking of the driver is insufficient because the driver wears glasses, the drive may be determined to be not drowsy even though the driver is actually drowsy. When the warning is not issued to the driver based on such an erroneous determination, a safe operation of the vehicle may be hindered. Therefore, there is room for improvement in issuing a warning to the driver who is drowsy and whose condition is not appropriate for continuation of driving at a suitable timing without causing annoyance to the driver.

Therefore, it is an object of the present disclosure to provide a display control device, a display control method, and a display control program capable of guiding a manager to issue a warning to a driver whose condition is not appropriate for the continuation of driving at a suitable timing without causing annoyance to the driver.

A display control device according to a first aspect of the present disclosure includes: an acquisition unit that acquires a facial image of a driver of a vehicle captured by an imaging unit; a determination unit that determines appropriateness of continuation of driving by the driver based on the facial image acquired by the acquisition unit; and control unit that, in a case where the determination unit determines that there is a possibility that the continuation of the driving by the driver is not appropriate, causes a display unit on a manager side, the manager managing the driver, to display the facial image based on which the determination unit determines that there is the possibility that the continuation of the driving by the driver is not appropriate.

In the display control device according to the first aspect, the acquisition unit acquires the facial image of the driver of the vehicle captured by the imaging unit. Further, the determination unit determines the appropriateness of the continuation of driving by the driver based on the facial image acquired by the acquisition unit. Then, the control unit, in the case where the determination unit determines that there is the possibility that the continuation of the driving by the driver is not appropriate, causes the display unit on the manager side, the manager managing the driver, to display the facial image based on which the determination unit determines that there is the possibility that the continuation of the driving by the driver is not appropriate. With this configuration, in the display control device, the facial image based on which the determination unit determines that there is the possibility that the continuation of the driving by the driver is not appropriate is displayed on the display unit on the manager side, whereby the manager can decide whether to caution or issue an instruction such as warning to the driver based on the facial image. Therefore, in the display control device, it is possible to guide the manager to issue a warning at a suitable timing without causing annoyance to the driver whose condition is not appropriate for the continuation of driving.

In the first aspect above, the control unit causes the display unit to display information with which the driver is uniquely identifiable when the determination unit determines that there is the possibility that the continuation of the driving by the driver is not appropriate.

In the display control device of the above aspect, the control unit causes the display unit to display information with which the driver is uniquely identifiable when the determination unit determines that there is the possibility that the continuation of the driving by the driver is not appropriate. With this configuration, in the display control device, the information with which the driver can be uniquely identified is displayed on the display unit on the manager side, whereby the manager can identify the driver who has the possibility that the continuation of the driving by the driver is not appropriate based on the information.

In the aspect above, the control unit causes the display unit to display contact information of the driver when the determination unit determines that there is the possibility that the continuation of the driving by the driver is not appropriate.

In the display control device of the above aspect, the control unit causes the display unit on the manager side to display contact information of the driver when the determination unit determines that there is the possibility that the continuation of the driving by the driver is not appropriate. With this configuration, in the display control device, the contact information of the driver is displayed on the display unit on the manager side, whereby the manager can easily contact the driver who has the possibility that the continuation of the driving by the driver is not appropriate using the contact information.

In the aspect above, the determination unit determines whether the driver is drowsy as the appropriateness of the continuation of driving by the driver based on the facial image acquired by the acquisition unit; and the control unit, in the case where the determination unit determines that there is the possibility that the driver is drowsy, causes the display unit to display the facial image based on which the determination unit determines that there is the possibility that the driver is drowsy.

In the display control device of the above aspect, the determination unit determines whether the driver is drowsy as the appropriateness of the continuation of driving by the driver based on the facial image acquired by the acquisition unit. Then, the control unit, in the case where the determination unit determines that there is the possibility that the driver is drowsy, causes the display unit on the manager side to display the facial image based on which the determination unit determines that there is the possibility that the driver is drowsy. With this configuration, in the display control device, the facial image based on which the determination unit determines that there is the possibility that the driver is drowsy is displayed on the display unit on the manager side, whereby the manager can decide whether to caution or issue an instruction such as warning to the driver based on the facial image. Therefore, in the display control device, it is possible to guide the manager to issue a warning at a suitable timing without causing annoyance to the driver whose condition is not appropriate for the continuation of driving.

In the aspect above, the control unit, in the case where the determination unit determines that there is the possibility that the driver is drowsy, causes the display unit to display information related to a status when the determination unit determines that there is the possibility that the driver is drowsy.

In the display control device of the above aspect, the control unit, in the case where the determination unit determines that there is the possibility that the driver is drowsy, causes the display unit on the manager side to display information related to a status when the determination unit determines that there is the possibility that the driver is drowsy. With this configuration, in the display control device, the facial image based on which when the determination unit determines that there is the possibility that the driver is drowsy is displayed on the display unit on the manager side, whereby an accuracy of the prediction by the manager whether the driver is drowsy can be enhanced.

In a display control method according to a second aspect of the present disclosure, a computer executes processes including: acquiring a facial image of a driver of a vehicle captured by an imaging unit; determining appropriateness of continuation of driving by the driver based on the facial image acquired; and in a case where there is a possibility that the continuation of the driving by the driver is not appropriate, causing a display unit on a manager side, the manager managing the driver, to display the facial image based on which a determination is made that there is the possibility that the continuation of the driving by the driver is not appropriate.

A display control program according to a third aspect of the present disclosure causes a computer to execute processes including: acquiring a facial image of a driver of a vehicle captured by an imaging unit; determining appropriateness of continuation of driving by the driver based on the facial image acquired; and in a case where there is a possibility that the continuation of the driving by the driver is not appropriate, causing a display unit on a manager side, the manager managing the driver, to display the facial image based on which a determination is made that there is the possibility that the continuation of the driving by the driver is not appropriate.

As described above, in the display control device, the display control method, and the display control program according to the present disclosure, it is possible to guide the manager to issue a warning to the driver whose condition is not appropriate for the continuation of driving at a suitable timing without causing annoyance to the driver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a display control system according to the present embodiment;

FIG. 2 is a block diagram showing a hardware configuration of a display control device, a manager terminal, and a driver terminal according to the present embodiment;

FIG. 3 is a block diagram showing an example of a functional configuration of the display control device according to the present embodiment;

FIG. 4 is a block diagram showing a hardware configuration of a vehicle according to the present embodiment;

FIG. 5 is a flowchart showing a flow of a display process executed by the display control device according to the present embodiment; and

FIG. 6 is a display example of a Web application displayed on the manager terminal according to the present embodiment.

### DETAILED DESCRIPTION OF EMBODIMENTS

Hereinafter, a display control system 10 according to the present embodiment will be described.

The display control system 10 according to the present embodiment is a system that executes display control of a Web application that can be viewed by a manager who manages a driver of a business operator that operates a vehicle, such as a taxi company and a transportation company.

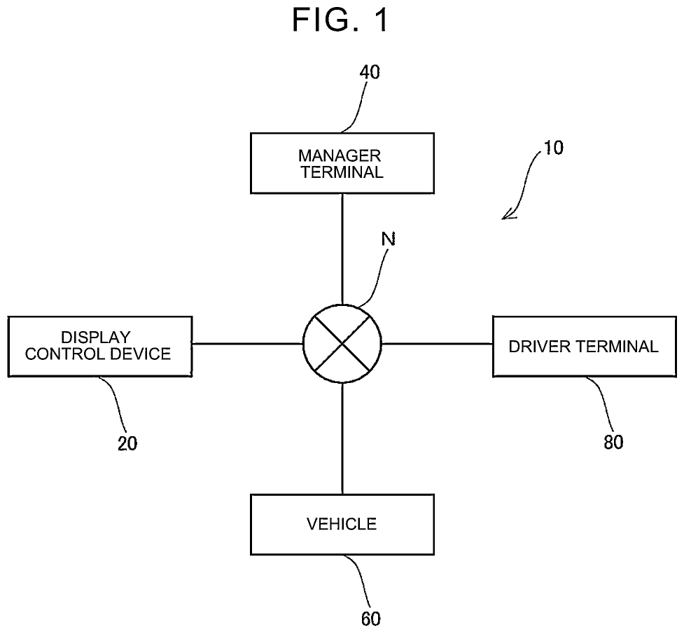

FIG. 1 is a diagram showing a schematic configuration of the display control system 10.

As shown in FIG. 1, the display control system 10 includes a display control device 20, a manager terminal 40, a vehicle 60, and a driver terminal 80. The display control device 20, the manager terminal 40, the vehicle 60, and the driver terminal 80 are connected via a network N and are communicable with each other. The vehicle 60 connected to the network N is, for example, an automobile that travels while carrying a user.

The display control device 20 is a server computer owned by a business operator that manages the vehicle 60.

The manager terminal 40 is a terminal owned by the manager. As an example, a general-purpose computer device such as a server computer or a personal computer (PC), or a portable terminal such as a portable PC (notebook PC), a smartphone, or a tablet terminal, is applied to the manager terminal 40. In the present embodiment, as an example, the manager terminal 40 is a PC.

The vehicle 60 may be a gasoline vehicle, a hybrid electric vehicle, or a battery electric vehicle. However, in the present embodiment, the vehicle 60 is a gasoline vehicle as an example.

The driver terminal 80 is a mobile terminal owned by the driver of the vehicle 60. As an example, a notebook PC, a smartphone, a tablet terminal, or the like is applied to the driver terminal 80. In the present embodiment, as an example, the driver terminal 80 is a smartphone.

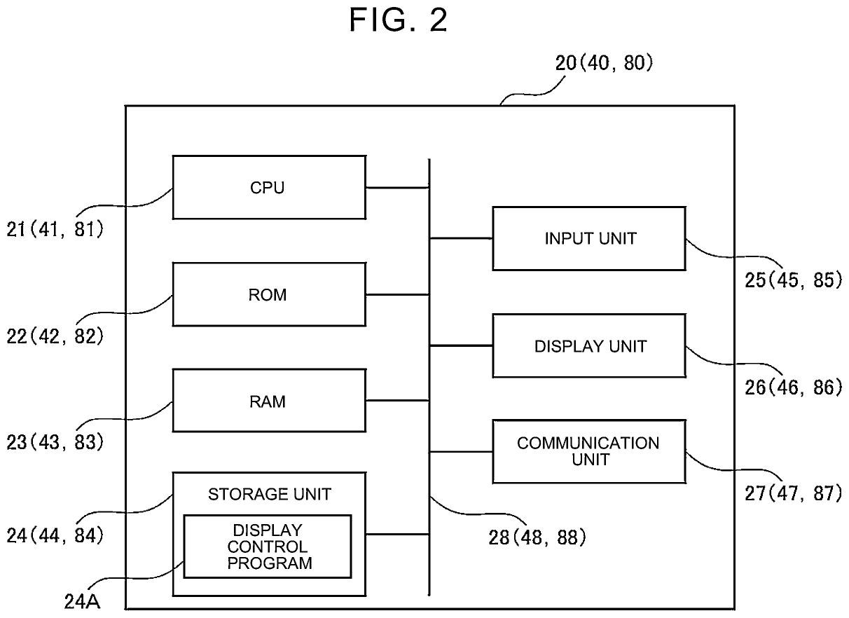

Next, the hardware configuration of the display control device 20, the manager terminal 40, and the driver terminal 80 will be described. FIG. 2 is a block diagram showing the hardware configuration of the display control device 20, the manager terminal 40, and the driver terminal 80. The display control device 20, the manager terminal 40, and the driver terminal 80 basically have a general computer configuration. Therefore, the display control device 20 will be described as a representative.

As shown in FIG. 2, the display control device 20 includes a central processing unit (CPU) 21, a read-only memory (ROM) 22, a random access memory (RAM) 23, a storage unit 24, an input unit 25, a display unit 26, and a communication unit 27. The configurations are communicably connected to each other via a bus 28.

The CPU 21 is a central processing unit that executes various programs and that controls various units. That is, the CPU 21 reads the program from the ROM 22 or the storage unit 24 and executes the program using the RAM 23 as a work area. The CPU 21 controls each of the above configurations and performs various arithmetic processes in accordance with the program recorded in the ROM 22 or the storage unit 24.

The ROM 22 stores various programs and various data. The RAM 23 temporarily stores a program or data as a work area.

The storage unit 24 is composed of a storage device such as a hard disk drive (HDD), a solid state drive (SSD), or a flash memory, and stores various programs and various data. In the present embodiment, the storage unit 24 stores at least a display control program 24A for executing a display process that will be described later.

The input unit 25 includes a pointing device such as a mouse, a keyboard, a microphone, a camera, and the like, and is used for performing various inputs.

The display unit 26 is, for example, a liquid crystal display and displays various types of information. A touch panel may be adopted as the display unit 26 and may function as the input unit 25.

The communication unit 27 is an interface for communicating with other devices. For the communication, for example, a wired communication standard such as Ethernet (registered trademark) or fiber-distributed data interface (FDDI), or a wireless communication standard such as fourth generation (4G), fifth generation (5G), or Wi-Fi (registered trademark) is used.

When executing the above-mentioned display control program 24A, the display control device 20 executes the processes based on the above-mentioned display control program 24A using the above-mentioned hardware resources.

Next, the functional configuration of the display control device 20 will be described.

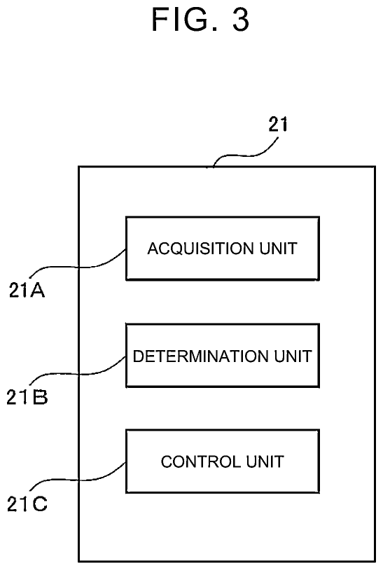

FIG. 3 is a block diagram showing an example of a functional configuration of the display control device 20 according to the present embodiment.

As shown in FIG. 3, the CPU 21 of the display control device 20 includes an acquisition unit 21A, a determination unit 21B, and a control unit 21C as functional configurations. Each functional configuration is realized when the CPU 21 reads and executes the display control program 24A stored in the storage unit 24.

The acquisition unit 21A acquires the facial image of the driver of the vehicle 60 captured by a camera 75 that will be described later. The facial image only needs to include an image of the face of the driver. The facial image may be composed of only the image of the face of the driver, or may include an image of the body of the driver in addition to the image of the face of the driver.

The determination unit 21B determines appropriateness of continuation of driving by the driver based on the facial image acquired by the acquisition unit 21A. In the present embodiment, the determination unit 21B determines whether the driver is drowsy as the appropriateness of the continuation of driving by the driver based on the facial image acquired by the acquisition unit 21A. Specifically, the determination unit 21B executes, for example, a known drowsiness determination process as described in Japanese Unexamined Patent Application Publication No. 8-153288 (JP 8-153288 A) using the facial image acquired by the acquisition unit 21A so as to determine whether the driver is drowsy.

When the determination unit 21B determines that there is a possibility that the driver is drowsy, the control unit 21C causes a display unit 46 of the manager terminal 40 to display the driver information when the determination unit 21B determines that there is the possibility that the driver is drowsy. The display unit 46 is an example of a “display unit on the manager side”. As an example, the driver information includes the facial image of the driver, a driver identification (ID) that is information with which the driver can be uniquely identified, contact information of the driver, and time information that will be described later. A specific example of the driver information displayed on the display unit 46 will be described later. Further, the driver information is stored in the storage unit 24 as an example.

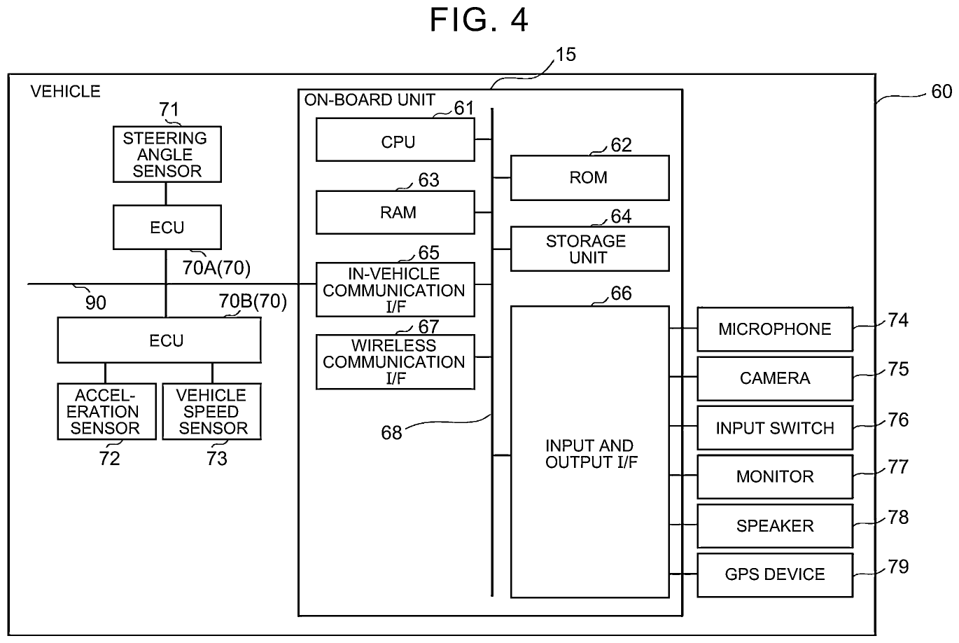

Next, the hardware configuration of the vehicle 60 will be described. FIG. 4 is a block diagram showing a hardware configuration of the vehicle 60.

As shown in FIG. 4, the vehicle 60 is configured to include an on-board device 15, a plurality of electronic control units (ECUs) 70, a steering angle sensor 71, an acceleration sensor 72, a vehicle speed sensor 73, a microphone 74, the camera 75, an input switch 76, a monitor 77, a speaker 78, and a global positioning system (GPS) device 79.

The on-board device 15 is configured to include a CPU 61, a ROM 62, a RAM 63, a storage unit 64, an in-vehicle communication interface (I/F) 65, an input and output I/F 66, and a wireless communication I/F 67. The CPU 61, the ROM 62, the RAM 63, the storage unit 64, the in-vehicle communication I/F 65, the input and output I/F 66, and the wireless communication I/F 67 are connected to each other so as to be communicable with each other via an internal bus 68.

The CPU 61 is a central processing unit that executes various programs and that controls various units. That is, the CPU 61 reads the program from the ROM 62 or the storage unit 64 and executes the program using the RAM 63 as a work area. The CPU 61 controls each of the above configurations and performs various arithmetic processes in accordance with the program recorded in the ROM 62 or the storage unit 64.

The ROM 62 stores various programs and various data. The RAM 63 temporarily stores a program or data as a work area.

The storage unit 64 is composed of a storage device such as an HDD, an SSD, or a flash memory, and stores various programs and various data.

The in-vehicle communication I/F 65 is an interface for connecting to the ECUs 70. For the interface, a communication standard based on a controller area network (CAN) protocol is used. The in-vehicle communication I/F 65 is connected to an external bus 90.

The ECU 70 is provided for each function of the vehicle 60, and in the present embodiment, an ECU 70A and an ECU 70B are provided. The ECU 70A is exemplified by an electric power steering ECU, and the steering angle sensor 71 is connected to the ECU 70A. Further, the ECU 70B is exemplified by a vehicle stability control (VSC) ECU, and the acceleration sensor 72 and the vehicle speed sensor 73 are connected to the ECU 70B. In addition to the acceleration sensor 72 and the vehicle speed sensor 73, a yaw rate sensor may be connected to the ECU 70B.

The steering angle sensor 71 is a sensor for detecting the steering angle of the steering wheel. The steering angle detected by the steering angle sensor 71 is stored in the storage unit 64 and transmitted to the display control device 20 as the vehicle information.

The acceleration sensor 72 is a sensor for detecting the acceleration acting on the vehicle 60. The acceleration sensor 72 is, for example, a three-axis acceleration sensor that detects the acceleration applied in the vehicle front-rear direction as the X-axis direction, the vehicle width direction as the Y-axis direction, and the vehicle height direction as the Z-axis direction. The acceleration detected by the acceleration sensor 72 is stored in the storage unit 64 and transmitted to the display control device 20.

The vehicle speed sensor 73 is a sensor for detecting a vehicle speed of the vehicle 60. The vehicle speed sensor 73 is, for example, a sensor provided on a vehicle wheel. The vehicle speed detected by the vehicle speed sensor 73 is stored in the storage unit 64 and transmitted to the display control device 20.

The input and output I/F 66 is an interface for communicating with the microphone 74, the camera 75, the input switch 76, the monitor 77, the speaker 78, and the GPS device 79 mounted on the vehicle 60.

The microphone 74 is a device provided on the front pillar, a dashboard, or the like of the vehicle 60, and collects voices emitted by the driver of the vehicle 60. The microphone 74 may be provided in the camera 75 that will be described later.

The camera 75 is configured to include a charge coupled device (CCD) image sensor as an example. As an example, the camera 75 is provided on the upper portion of the windshield or the dashboard of the vehicle 60 and is directed toward the driver. Then, the camera 75 captures a range including the face of the driver. The facial image of the driver captured by the camera 75 is stored in the storage unit 64 and transmitted to the display control device 20. Further, the camera 75 may be connected to the on-board device 15 via the ECU 70 (for example, a camera ECU). The camera 75 is an example of an “imaging unit”.

The input switch 76 is provided on the instrument panel, the center console, the steering wheel, or the like, and is a switch for inputting an operation by fingers of the driver. As the input switch 76, for example, a push button type numeric keypad, a touch pad, or the like can be adopted.

The monitor 77 is a liquid crystal monitor provided on an instrument panel, a meter panel, or the like, for displaying an image of an operation proposal related to a function of the vehicle 60 and an explanation of the function. The monitor 77 may be provided as a touch panel that also serves as the input switch 76.

The speaker 78 is a device provided on the instrument panel, the center console, the front pillar, the dashboard, or the like, for outputting a voice for the operation proposal related to the function of the vehicle 60 and the explanation of the function. Note that, the speaker 78 may be provided on the monitor 77.

The GPS device 79 is a device that measures the current position of the vehicle 60. The GPS device 79 includes an antenna (not shown) that receives signals from GPS satellites. Note that, the GPS device 79 may be connected to the on-board device 15 via a car navigation system connected to the ECU 70 (for example, a multimedia ECU).

The wireless communication I/F 67 is a wireless communication module for communicating with the display control device 20. For the wireless communication module, for example, communication standards such as 5G, long term evolution (LTE), and Wi-Fi (registered trademark) are used. The wireless communication I/F 67 is connected to the network N.

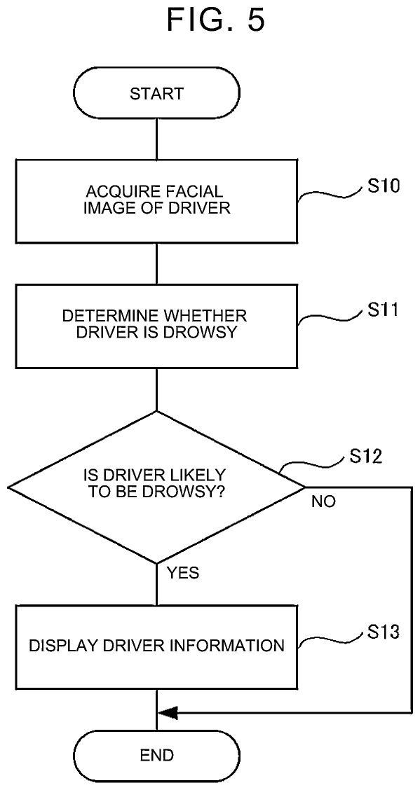

FIG. 5 is a flowchart showing the flow of a display process for displaying the driver information on the display unit 46 executed by the display control device 20 when the determination unit 21B determines that there is the possibility that the driver is drowsy. The display process is executed when the CPU 21 reads the display control program 24A from the storage unit 24, expands the display control program 24A into the RAM 23, and executes the program.

In step S10 shown in FIG. 5, the CPU 21 acquires the facial image of the driver from the vehicle 60. Then, the process proceeds to step S11. In the present embodiment, the facial image is periodically transmitted from the vehicle 60 to the display control device 20.

In step S11, the CPU 21 determines whether the driver is drowsy as the appropriateness of the continuation of driving by the driver based on the facial image acquired in step S10. Then, the process proceeds to step S12.

In step S12, the CPU 21 determines whether there is the possibility that the driver is drowsy. When the CPU 21 determines that there is the possibility that the driver is drowsy (step S12: YES), the process proceeds to step S13. On the other hand, when the CPU 21 determines that there is not the possibility that the driver is drowsy (step S12: NO), the process ends. As an example, the CPU 21 executes a known drowsiness determination process using the facial image acquired in step S10, and determines whether the driver is drowsy.

In step S13, the CPU 21 causes the display unit 46 of the manager terminal 40 to display the driver information when the CPU 21 determines that there is the possibility that the driver is drowsy. Then, the process ends.

Next, in step S13 shown in FIG. 5, a display example of the Web application displayed on the display unit 46 of the manager terminal 40 will be described.

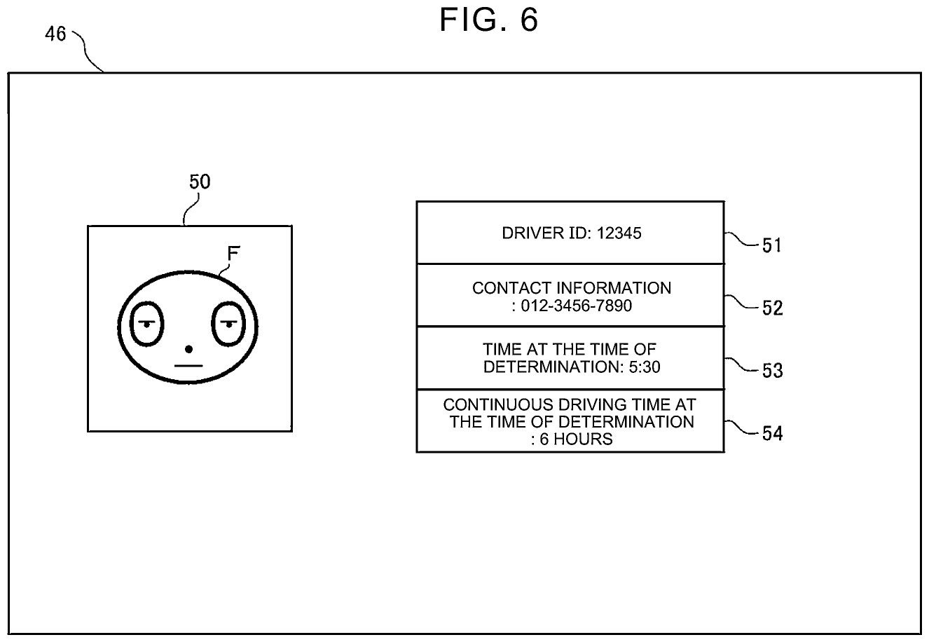

FIG. 6 is a display example of the Web application displayed on the display unit 46 of the manager terminal 40. When the CPU 21 determines in step S12 shown in FIG. 5 that “there is the possibility that the driver is drowsy”, the CPU 21 transmits a push notification to the manager terminal 40. Then, the display example shown in FIG. 6 is displayed when the push notification transmitted from the display control device 20 is opened on the manager terminal 40, as an example.

In the display example shown in FIG. 6, a first display portion 50, a second display portion 51, a third display portion 52, a fourth display portion 53, and a fifth display portion 54 are displayed.

The first display portion 50 is a portion that displays the facial image acquired in step S10 shown in FIG. 5 as the facial image of the driver when the CPU 21 determines that there is the possibility that the driver is drowsy. As an example, a facial image F of a driver A acquired in step S10 shown in FIG. 5 is displayed on the first display portion 50 shown in FIG. 6.

The second display portion 51 is a portion that displays the driver ID of the driver determined that there is the possibility that the driver is drowsy. As an example, the second display portion 51 shown in FIG. 6 displays that the driver ID of the driver A is “12345”.

The third display portion 52 is a portion that displays the telephone number of the driver terminal 80 as the contact information of the driver determined that there is the possibility that the driver is drowsy. As an example, the third display portion 52 shown in FIG. 6 displays that the telephone number of the driver terminal 80 owned by the driver A is “012-3456-7890”.

The fourth display portion 53 is a portion that displays time information related to time as information related to a status when the CPU 21 determines that there is the possibility that the driver is drowsy. Specifically, the fourth display portion 53 displays, as the time information, the time when the CPU 21 determines that there is the possibility that the driver is drowsy. As an example, the fourth display portion 53 shown in FIG. 6 displays that the time when the CPU 21 determines that there is the possibility that the driver A is drowsy is “5:30”.

The fifth display portion 54 is a portion that displays the time information when the CPU 21 determines that there is the possibility that the driver is drowsy. Specifically, the fifth display portion 54 displays, as the time information, continuous driving time of the vehicle 60 when the CPU 21 determines that there is the possibility that the driver is drowsy. As an example, the fifth display portion 54 shown in FIG. 6 displays that the continuous driving time of the vehicle 60 when the CPU 21 determines that there is the possibility that the driver A is drowsy is “6 hours”. Note that, in the present embodiment, as an example, the continuous driving time is calculated while the time when an ignition sensor (not shown) is turned on is regarded as a traveling start time of the vehicle 60, and the time when the ignition sensor is turned off is regarded as a traveling end time of the vehicle 60.

As described above, in the present embodiment, the CPU 21 acquires the facial image of the driver of the vehicle 60 captured by the camera 75. Further, the CPU 21 determines whether the driver is drowsy as the appropriateness of the continuation of driving by the driver based on the acquired facial image. Then, when the CPU 21 determines that there is the possibility that the driver is drowsy, the CPU 21 causes the display unit 46 of the manager terminal 40 to display the facial image when the CPU 21 determines that there is the possibility that the driver is drowsy. With this configuration, in the present embodiment, the facial image when the CPU 21 determines that there is the possibility that the driver is drowsy is displayed on the display unit 46, whereby the manager can decide whether to caution or issue an instruction such as warning to the driver based on the facial image. Therefore, in the present embodiment, it is possible to guide the manager to issue a warning at a suitable timing without causing annoyance to the driver whose condition is not appropriate for continuation of driving.

Further, in the present embodiment, when the CPU 21 determines that there is the possibility that the driver is drowsy, the CPU 21 causes the display unit 46 of the manager terminal 40 to display the driver ID of the driver. With this process, in the present embodiment, the driver ID is displayed on the display unit 46, whereby the manager can identify the driver who has the possibility that the driver is drowsy based on the driver ID.

Further, in the present embodiment, when the CPU 21 determines that there is the possibility that the driver is drowsy, the CPU 21 causes the display unit 46 of the manager terminal 40 to display the contact information of the driver. With this configuration, in the present embodiment, the contact information of the driver is displayed on the display unit 46, whereby the manager can easily contact the driver who has the possibility that the driver is drowsy using the contact information.

Further, in the present embodiment, when the CPU 21 determines that there is the possibility that the driver is drowsy, the CPU 21 causes the display unit 46 of the manager terminal 40 to display the time information related to time as the information on the status when the CPU 21 determines that there is the possibility that the driver is drowsy. Specifically, the CPU 21 causes the display unit 46 to display, as time information, the time and the continuous driving time of the vehicle 60 when the CPU 21 determines that there is the possibility that the driver is drowsy. Here, as a result of the investigation by the applicant, it has been found that there is no driver who does not feel drowsy during work among the drivers of the business operators operating vehicles such as taxi companies and transportation companies. In addition, as a result of the investigation by the applicant, it has also been found that an accident caused by the driver of the business operator is highly likely to occur at dawn, and the accident that occurs at dawn is highly likely to be a serious accident. Therefore, in the present embodiment, the time information when the CPU 21 determines that there is the possibility that the driver is drowsy is displayed on the display unit 46, whereby the manager can predict whether the driver is drowsy in consideration of the time. Further, in the present embodiment, the continuous driving time of the vehicle 60 when the CPU 21 determines that there is the possibility that the driver is drowsy is displayed on the display unit 46, whereby the manager can predict whether the driver is drowsy in consideration of the continuous driving time. With this configuration, in the present embodiment, the time information when the CPU 21 determines that there is the possibility that the driver is drowsy is displayed on the display unit 46, whereby an accuracy of the prediction by the manager whether the driver is drowsy can be enhanced.

Others

In the above embodiment, whether the driver is drowsy is determined as the appropriateness of the continuation of driving by the driver. However, the present disclosure is not limited to this, and whether the driver is in the good health condition or whether the driver is engaging in so called distracted driving as may be determined as the appropriateness of the continuation of driving by the driver.

In the above embodiment, the appropriateness of the continuation of driving by the driver is determined based on the acquired facial image of the driver. However, the determination on the appropriateness the continuation of driving is not limited to the use of the facial image, and may be performed using other elements. As another example, information such as the electrocardiogram, heartbeat, pulse wave, respiration, and brain wave of the driver may be acquired as the information related to the driver such as the facial image of the driver, and the appropriateness of the continuation of driving by the driver may be determined based on the acquired information. Further, instead of or in addition to use of the information related to the driver, vehicle information related to the vehicle may be used to determine the appropriateness of the continuation of driving by the driver. In this case, the appropriateness of the continuation of driving by the driver may be determined using the steering angle of the steering wheel and the operation of each pedal acquired as the vehicle information.

In the above embodiment, when the CPU 21 determines that there is the possibility that the driver is drowsy, the display unit 46 of the manager terminal 40 is caused to display the facial image of the driver, the driver ID of the driver, the contact information of the driver, and the time information as the driver information when the CPU 21 determines that there is the possibility that the driver is drowsy. However, the information to be displayed as the driver information may include at least the facial image of the driver, and may include remaining driver ID, contact information, and time information of the driver or may not include some information.

In the above embodiment, an example of the information with which the driver can be uniquely identified is the driver ID. However, the present disclosure is not limited to this, and an example of the information with which the driver can be uniquely identified may be another type of information such as a “name of the driver”.

In the above embodiment, an example of the contact information of the driver is the telephone number of the driver terminal 80. However, the present disclosure is not limited to this, and an example of the contact information of the driver may be another type of information such as an “e-mail address of the driver terminal 80”.

In the above embodiment, the display control system 10 includes the display control device 20, the manager terminal 40, a vehicle 60, and the driver terminal 80. However, the present disclosure is not limited to this, and the display control system 10 may not include the manager terminal 40, and one device may have the functions of the display control device 20 and the manager terminal 40.

It should be noted that various processors other than the CPU may execute the display process that is executed when the CPU 21 reads the software (program) in the above embodiment. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. Further, the display process may be executed by one of these various processors, or a combination of two or more processors of the same type or different types (for example, a combination of FPGAs, a combination of a CPU and an FPGA, and the like). Further, the hardware structure of these various processors is, more specifically, an electric circuit in which circuit elements such as semiconductor elements are combined.

Further, in the above embodiment, the mode in which the display control program 24A is stored (installed) in the storage unit 24 in advance has been described, but the present disclosure is not limited to this. The display control program 24A may be stored in a storage medium such as a compact disc read-only memory (CD-ROM), a digital versatile disc read-only memory (DVD-ROM), and a universal serial bus (USB) memory to be provided. Further, the display control program 24A may be downloaded from an external device via the network N.

What is claimed is:

1. A display control device comprising:
an acquisition unit that acquires a facial image of a driver of a vehicle captured by an imaging unit;
a determination unit that determines appropriateness of continuation of driving by the driver based on the facial image acquired by the acquisition unit; and
a control unit that, in a case where the determination unit determines that there is a possibility that the continuation of the driving by the driver is not appropriate, causes a display unit on a manager side, the manager managing the driver, to display the facial image based on which the determination unit determines that there is the possibility that the continuation of the driving by the driver is not appropriate.

2. The display control device according to claim 1, wherein the control unit causes the display unit to display information with which the driver is uniquely identifiable when the determination unit determines that there is the possibility that the continuation of the driving by the driver is not appropriate.

3. The display control device according to claim 1, wherein the control unit causes the display unit to display contact information of the driver when the determination unit determines that there is the possibility that the continuation of the driving by the driver is not appropriate.

4. The display control device according to claim 1, wherein:
the determination unit determines whether the driver is drowsy as the appropriateness of continuation of driving by the driver based on the facial image acquired by the acquisition unit; and
the control unit, in a case where the determination unit determines that there is a possibility that the driver is drowsy, causes the display unit to display the facial image based on which the determination unit determines that there is the possibility that the driver is drowsy.

5. The display control device according to claim 4, wherein the control unit, in the case where the determination unit determines that there is the possibility that the driver is drowsy, causes the display unit to display information related to a status when the determination unit determines that there is the possibility that the driver is drowsy.

6. A display control method in which a computer executes processes comprising:
acquiring a facial image of a driver of a vehicle captured by an imaging unit;
determining appropriateness of continuation of driving by the driver based on the facial image acquired; and
in a case where there is a possibility that the continuation of the driving by the driver is not appropriate, causing a display unit on a manager side, the manager managing the driver, to display the facial image based on which a determination is made that there is the possibility that the continuation of the driving by the driver is not appropriate.

7. A display control program causing a computer to execute processes comprising:
acquiring a facial image of a driver of a vehicle captured by an imaging unit;
determining appropriateness of continuation of driving by the driver based on the facial image acquired; and
in a case where there is a possibility that the continuation of the driving by the driver is not appropriate, causing a display unit on a manager side, the manager managing the driver, to display the facial image based on which a determination is made that there is the possibility that the continuation of the driving by the driver is not appropriate.
